(19) United States
(12) Patent Application Publication
(10) Pub. No.: US 2009/0266752 A1
(43) Pub. Date: Oct. 29, 2009

(54) Capillary-like connector for liquid chromatography, in particular, high-performance liquid chromatography with reduced dispersion and improved thermal characteristics

(76) Inventors: Hermann Hochgraeber, Offenberg (DE); Joachim Wiechers, Planegg (DE)

Correspondence Address: THE CULBERTSON GROUP, P.C., 1114 LOST CREEK BLVD., SUITE 420, AUSTIN, TX, 78746, US

(21) Appl. No.: 12/398,004

(22) Filed: Mar. 4, 2009

(30) Foreign Application Priority Data
Mar. 5, 2008 (DE) 10 2008 012 798.1

(51) Int. Cl. B01D 15/10

(52) U.S. Cl. 210/137

(57) ABSTRACT

The invention concerns a capillary-like connector to conduct liquid, in particular, for liquid chromatography, wherein the connector 50, 55 has changing inside cross sections in shape and/or position in the direction of a main flow direction, and an arrangement for liquid chromatography with at least one such capillary-like connector 50, 55.

The invention concerns capillary-like connectors with the features of the preamble of Claim 1, as they are used, for example, in liquid chromatography, in particular, high-performance liquid chromatography (HPLC).

In an HPLC unit, the chromatographic components, such as the eluent reservoir, pump, valves, mixing chamber, injector, separation column, detector unit, etc., are mainly connected to one another fluidically via capillaries. A liquid flow, which is partially under high pressure and which is conveyed by a suitable pump, flows through these connections. The sample to be examined is injected into the injector of the HPLC unit and consequently flows, via a fluidic connection, to the separation column. The volume enclosed in the connectors should be as small as possible, so that the running times of a chromatographic analysis are as short as possible, and the transitions between the sample and the moving solvent (eluent) and/or between moving solvents of different compositions are changed as little as possible by the flow profiles that arise in the capillaries.

This can be attained by a reduction of the connector length as well as by a diminution of the inside diameter of the capillaries. However, there is a certain minimal length of these connectors, since the connection sites of the chromatographic components of an HPLC unit cannot be placed next to one another arbitrarily closely, due to the shape and extension. Also, the inside diameter of the capillaries cannot be reduced arbitrarily, since otherwise, an excessively high back pressure would be produced by such a connection and the risk of clogging would be increased, which would compromise the robustness of the HPLC unit.

Such connectors available on the market for HPLC, designed with somewhat flexible capillaries with a circular cross section, are mostly made of steel.

If after the injection of a sample into the liquid flow, the average sample concentration at the end of a connection capillary is observed, which arises over the capillary cross section, then a sudden transition between the mobile solvent and the sample is no longer obtained. The longer the capillary, the flatter the transitions. This effect of the longitudinal thorough mixing by dissimilar flow rates is called dispersion in HPLC.

The dispersion, however, has a disadvantageous effect on the separation of the individual sample components at the end of a chromatographic column. On the way to the detector, sample components still exiting separately from the column, are thoroughly temporally mixed longitudinally by the dispersion in the connector between the column and the detector, so that a separation and quantification of the two sample components in the chromatogram is no longer possible.

Also, the dispersion in the connector between the injector and column has a disadvantageous effect on the separation performance of an HPLC unit, since a sample volume, once spread and thinned out at its ends, also causes spread and thinned out sample volumes at the exit of the column.

The object of the invention is therefore to devise fluidic, capillary-like connectors for the components in a unit for liquid chromatography, in particular, high-performance liquid chromatography, and an arrangement for liquid chromatography that causes as small a thorough mixing as possible in the main flow direction of substances which follow, one behind the other, optimizes the separation performance, and thereby realizes a higher sample throughput as a result of the shorter sample running times, wherein the profitability of a unit increases.

The object of the capillary-like connector, in accordance with the invention, is therefore the liquid transport via a prespecified distance with as little dispersion as possible with a tenable back pressure.

The object of the invention is realized with the features of Claims 1 and 8.

The invention is based on the finding that in essentially cylindrically made fluidic connectors, a parabolic flow profile is formed with laminar flow. Such a flow profile is formed with known capillaries with a circular cross section, since even in bends (required for the connection of the individual components) with a radius that is large in comparison with the diameter of the capillaries, these capillaries comprise an essentially cylindrical liquid column, which is even strictly cylindrical over linear distances.

However, if the flow rates remain in the laminar range, the flow profile in such cylindrical liquid columns with a stationary wall is parabolic. In the middle of the capillary, along the cylinder axis, the result is thereby the highest flow rate in an axial direction. On the walls, on the other hand, the flow rate is theoretically zero, if the influence of diffusion is ignored, which, in actual practice, provides for an exchange of the most extreme boundary layer of the liquid column. If these diffusion effects are ignored, then the result for the fastest flowing parts of the liquid is a flow rate that, as a result of mass conservation, is twice as high as the average flow rate of the entire liquid column.

If a sample is injected into such a liquid flow, then there is obtained, in the first moment after the injection, two more or less sharply pronounced transitions between the sample and the moving solvent, which ideally represent planar circular areas, perpendicular to the middle axis of the capillaries. These boundary areas, however, are increasingly distorted due to the flow rates in the capillaries, which are dissimilar over the capillary cross section, so that the two circular areas become paraboloids.

With regard to the longitudinal through mixing of liquids which follow one another in the main flow direction, produced by the fluidic connection, this parabolic profile disadvantageously represents a worst case.

If, in accordance with the invention, the circular shape and/or position of the connection cross section is changed in an alternating manner along the course of the flow or the main flow direction (which in the unobstructed state of the capillary-like connector, corresponds to its middle longitudinal axis), then alternating radial flow components are forced and, in this way, the radial thorough mixing of the flowing liquids is reinforced in the connector, and thus the formation of the parabolic flow profile, as known from the strictly circular cross section, is disturbed and hindered.

The object of the invention is therefore attained in that the shape of the capillary-like connector is changed, again and again, at regular or irregular intervals, so that the usual parabolic rate profile is disturbed at these locations. In this way, the distribution of the throughflow times through the capillaries becomes narrower, which corresponds to a reduced dispersion. The fact that the changes of the shape and/or position of the connector cross section are not rotationally symmetric to the main flow direction makes it possible for a flowing molecule to have to change, again and again, to a path with another relative flow rate.

In an arbitrary implementation of the invention, the distance between two successive changes can be less than 20 mm, preferably, less than 10 mm or even less, for example, 5, 4, 3, 2, or 1 mm, so that the radial thorough mixing is correspondingly reinforced, since the more often the shape and/or position of the cross section with the throughflow is changed along the main flow direction, the better the radial thorough mixing takes place, and the weaker the formation of the parabolic flow profile, and more intensely the hindering of a longitudinal thorough mixing. The capillaries, in accordance with the invention, thus have dimensions, for example, of an inside diameter in the range of 10-1000 μm, in particular, 100-300 μm, and a length in the range of several millimeters to several hundred millimeters, which is very much greater in comparison with the inside diameter.

In a preferred implementation of the invention, the capillary-type connector essentially has a tubular shape, for example, made of stainless steel, glass, plastic, especially, PEEK, titanium, ceramic, or a composite material thereof, so that the center of the center points of the inside cross sectional areas, alternating in their shape, lie on an axis. The connector capillary can thereby be produced in a particularly simple manner in that it is pinched at preferably regular intervals, for example, perpendicular to the main flow direction, so that the previously cylindrical cross section becomes an ellipse at the pinched sites. Another improvement to the radial thorough mixing can also be attained, if the similarly major axes of two ellipses which follow one another are mutually perpendicular.

In another implementation of the invention, an additional reinforcement of the radial thorough mixing can be attained, in that before the formation of the ellipses, one inserts a relatively long solid body (core), for example, a solid cylinder, into the capillary, whose outside diameter is smaller than the inside diameter of the unshaped capillary. In this way, the side of the most rapid flow in the cylinder capillary is preferably occupied concentrically and the following liquid is displaced toward the capillary wall. In this way, the core can advantageously form a stop for the limitation of the shaping of the cylindrical capillary, in that it limits the length of the minor axes of the ellipses downwards, and in this way, simplifies production. Of course, however, it is also conceivable that the core is introduced, so that it is freely movable without permanent contact or a form-fitting connection to the inside wall of the capillary, and in this area, always essentially occupies the center of the inside cross section.

In another embodiment of the invention, the center points of the largely circular cross sections of a capillary follow a line, which is transverse to the main flow direction, for example, that is deflected (compressed) sinusoidally, preferably, largely periodically. With this embodiment, it is also possible, in another implementation and in a manner analogous to the example explained in above, to insert a core, which, by the displacement of the most rapid flow from the center by a stationary body, leads to another improvement of the radial thorough mixing at the expense of the longitudinal thorough mixing, which is detrimental to the separation performance. In order not to obtain an unnecessary expansion of volume, the deflections take place to such an extent that the jacket curve path length (of the longitudinal cross section) of the capillary to its (compressed) longitudinal extension is in a ratio smaller than 2:1, preferably, smaller than 1.5:1.

The longitudinal core introduced can close off flush with the ends of the capillary, lie staggered inwards, or also project, for example, in order to protrude in another connector (component or other capillary) or be fixed locally in a screw connector.

Of course, different embodiments of the alternating cross section modifications are conceivable in size and/or shape, as, for example, square, rectangular, triangular, oval, among one another, and/or in size.

Other embodiments of the invention can be drawn from the subclaims.

The invention is explained in more detail below with the aid of an embodiment example shown in the drawing. The drawing shows the following:

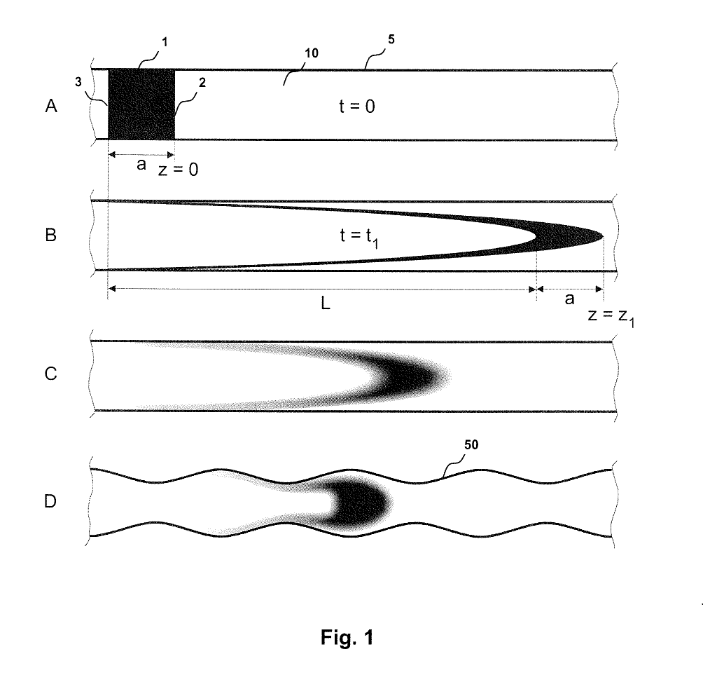

FIG. 1, a schematic longitudinal sectional representation of a capillary of an HPLC system with a second liquid quantity, introduced (injected) into a first liquid, shown in black, and the main course of the boundary layers between the two liquids at the time immediately after injection (A) and at a later time, with various assumptions with regard to diffusion and the shape of the capillary. To improve the representation of the conditions, only a thin layer from the injected liquid in the area of the center of the capillary is shown;

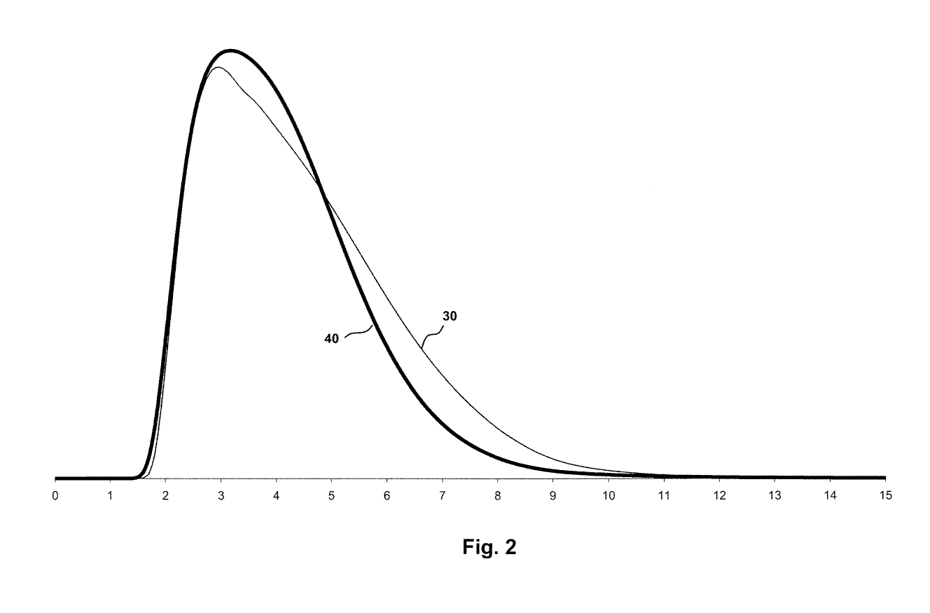

FIG. 2, the form of a first measurement signal of a UV detector to measure the concentration of a previously injected sample, which was directly connected at the end of a capillary that is shaped strictly cylindrically. The second measurement signal shows the form after an injection of the same sample quantity into the same capillary, but with changed periodically elliptical cross sectional modifications, in accordance with the invention, along the main flow direction, with 20 modifications over a length of 200 mm;

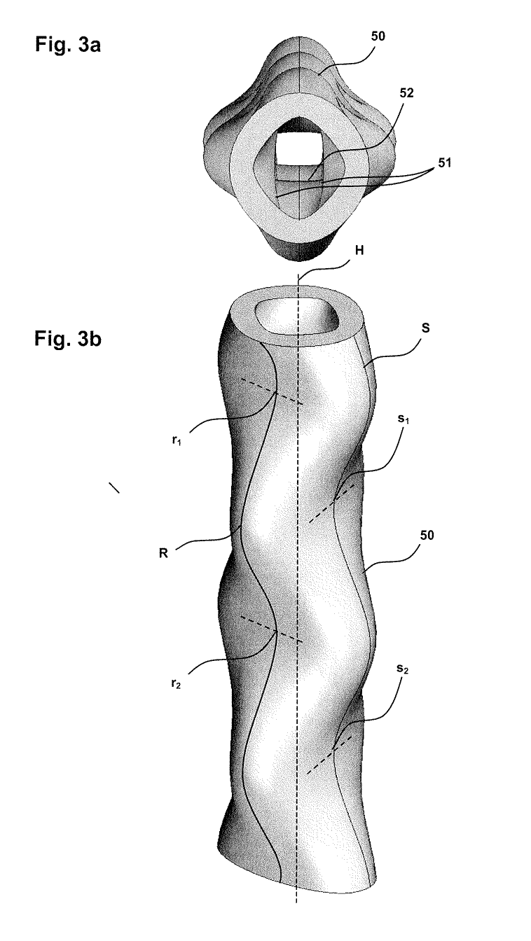

FIG. 3a, schematic representation of a first embodiment of a capillary shaped in accordance with the invention, with periodically elliptical cross sectional modifications, in a perspective front view;

FIG. 3b, schematic representation of the first embodiment according to FIG. 3a, in a perspective side view;

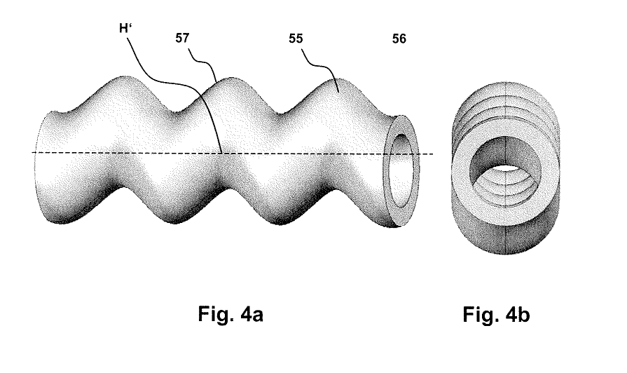

FIG. 4a, schematic representation of a second embodiment of a capillary shaped in accordance with the invention, with circular transverse sections, which are staggered, periodically transverse to the main flow direction, in a perspective side view;

FIG. 4b, schematic representation of the second embodiment according to FIG. 4a, in a perspective front view;

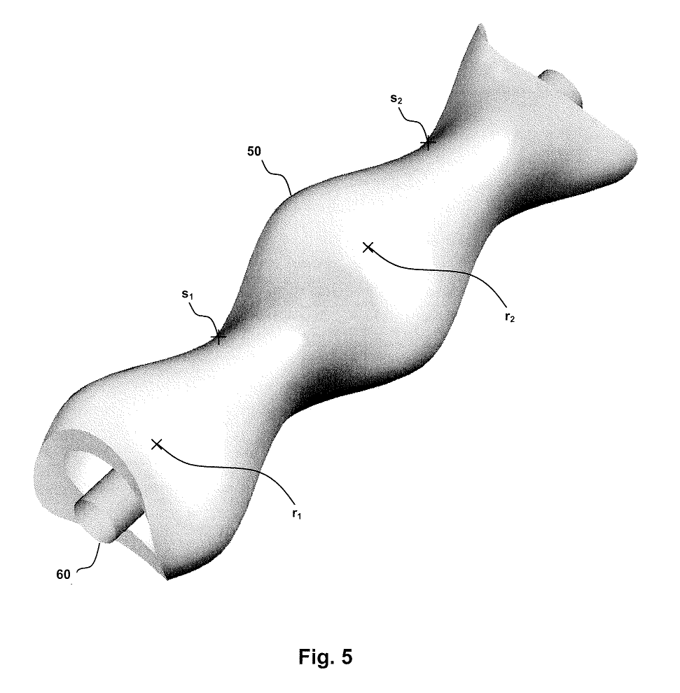

FIG. 5, schematic representation of a variant of the first embodiment according to FIG. 3a and FIG. 3b, with a solid-cylindrical core; and

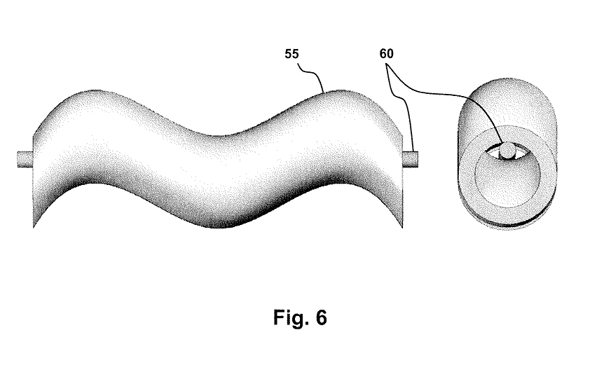

FIG. 6, schematic representation of a variant of the second embodiment according to FIG. 4a and FIG. 4b, with a solid-cylindrical core.

The cases represented among one another, in FIG. 1 in parts A to C, show the main course (flow in FIG. 1, from left to right) of the boundary layers between the two liquids in a cylindrical capillary 5 of an HPLC system, known in the state of the art, after the introduction (injection) of a second liquid quantity (sample) 1 into a first liquid quantity (mobile solvent or eluent) 10.

As can be seen from part A, at time t=0, immediately after the injection of sample 1 into the capillary 5, the injected sample quantity 1 fills an initially cylindrical volume with the circular basal areas 2 and 3, with height a.

The situation depicted in part B shows how, at a later time t=t₁, the basal areas 2 (in the movement direction forwards) and 3 (in the movement direction backwards) are shaped to form paraboloids, under the assumption that the liquid in the capillary has a laminar flow, but ignoring the diffusion that takes place between the liquids. Part C shows the situation in the capillary 5, at time t=t₁, under the assumption, on the other hand, that diffusion takes place between the liquids 1, 10 in the cylindrical capillary.

Part D, on the other hand, shows how the boundary layers in a capillary 50 in accordance with the invention form with periodically elliptical cross-sectional modifications, at time t=t₁, under the assumption that diffusion takes place between the liquids 1, 10.

To improve the depiction of the conditions, only a thin layer of the injected liquid is shown in the area of the center of the capillary in FIG. 1 in parts B to D.

FIG. 2 shows the comparison of two detector signals 30 and 40, proportional to the concentration of the sample in the moving solvent, as a function of time, as can be measured after the injection of a sample quantity of 10 μL into a capillary with a nominal inside diameter of 350 μm and a length of 250 mm, at the end of the capillaries 10 and 20 with the laminar throughflow. The thinly depicted curve 30 shows the signal during the injection into a strictly cylindrical capillary 10. The boldly depicted curve 40 shows the signal of an injection of the same sample quantity into a capillary, in accordance with the invention, which, in contrast to the previously mentioned strictly cylindrical capillary, was previously provided with 20 pairs of elliptical cross sectional modifications, which are perpendicular to one another. Here it can be clearly seen that the cross sectional deformations lead to a reduction of the peak width or dispersion, and thus the resolution capacity of an HPLC unit can be improved by using such capillaries.

FIG. 3a and FIG. 3b show a short piece of a capillary 50, as it was used to produce the results shown in FIG. 2. As can be seen, the cross sectional modifications, which are changed in accordance with the invention and are preferably periodically elliptical in this case, found along the main flow direction in the capillary 50, are formed by pinched locations r₁, s₁, r₂, s₂, which repeat at regular intervals, for example, of 10 mm. In this way, the path curves R and S are formed on the outside of the capillary 50 in longitudinal section planes, which are perpendicular to one another, with a common middle axis, instead of corresponding straight lines, as with a conventional strictly cylindrical capillary 5. As indicated, in FIG. 3b, as broken lines, pinched locations are present perpendicular to path curves R and S and thus perpendicular to the main flow direction H of the capillary 50.

Here it should be noted that the main flow direction in the unobstructed (and straight, preferably, cylindrical) state of a capillary corresponds to its middle longitudinal axis. If the capillary for the connection of components is bent with a radius that is normally substantially larger in comparison with the diameter, then the main flow direction is determined by the shortest path or the path of the least resistance within the capillary.

In this way, the elliptical cross sections, which can be seen in FIG. 3a and which change in shape along the longitudinal axis (main flow direction), are produced at the corresponding location on the inside of the capillary 50, which are formed by lines 51, opposite to one another, as a result of pinched locations on the outside of the capillary 50, which are opposite one another. Although the pinched locations, which are preferably mutually perpendicular and perpendicular to the main flow direction, are shown periodically in this embodiment, it is, of course, also conceivable that the deformations on the inside are also shaped irregularly by means of a subsequent pinching of a cylindrical capillary or in some other way.

FIG. 4a and FIG. 4b show a short piece of an alternative second embodiment of a capillary 55, in accordance with the invention, with circular cross sections, which are preferably staggered, periodically transverse to the main flow direction, and which, in comparison with a strictly cylindrical capillary, also create less dispersion in the connectors between the components of an HPLC unit. In this embodiment, the inside cross sectional area is retained as an area, in particular, a circular area with constant dimensions. However, a cross sectional change per deflection is also attained in the form of a line, especially, a sinusoidal line, leading through the cross sectional center, due to, for example, sinusoidal deflections 57, which follow one another closely (lying in the drawing plane in FIG. 4a), with an amplitude that is smaller when compared to the inside radius, seen in the direction of the main flow H′. Due to this staggering of circular cross section, cross sections that in turn change in their position along the main flow direction and that are effective in the flow direction are formed, so that viewed in the main flow direction, an eye 56 is produced.

Of course, it is also conceivable that instead of the depicted deflection within a longitudinal sectional plane, deflections are formed in several planes, in particular, longitudinal planes that are mutually perpendicular (with the longitudinal middle axis as the intersection line). Also, the features of the aforementioned embodiments can be arbitrarily combined with one another to form corresponding mixed forms, wherein, the introduction of a subsequently explained core in such mixed forms is also imaginable.

FIG. 5 shows a short piece of a capillary 50, according to FIG. 3a and FIG. 3b, but with the difference that a stationary, here, cylindrical, core 60 was introduced into the center of the capillary 50, in order to displace the fastest flowing liquid volume in the direction of the capillary wall, to further reduce the longitudinal thorough mixing of successive liquids, and to favor the radial thorough mixing. The outside diameter of the core 60 is thereby smaller than or the same as the minimal inside diameter of the cross sections at locations r₁, s₁, r₂, s₂, so that the core, in the form of a solid or closed hollow cylinder, fits snugly in a form-fitting manner at several locations of the inside of the capillary or can move over a small area. The straight core 60 thereby lies essentially concentric to the main flow direction, or the capillary middle axis 60 moves within a small area.

FIG. 6 shows a short piece of a capillary 55, according to FIG. 4a and FIG. 4b, but with the difference that a stationary, here, cylindrical core 60 was introduced into the center of the capillary 55, so as to displace the fastest flowing liquid volume in the direction of the capillary wall, to further reduce the longitudinal thorough mixing of successive liquids, and to favor the radial thorough mixing. The outside diameter of the core 60 is thereby smaller than or the same as the minimal inside diameter of the eye 56, so that the core, in the form of a solid or closed hollow cylinder, fits snugly in a form-fitting manner at several locations of the inside of the capillary or can move in a small area. Here, the straight core 60 is essentially concentric to the main flow direction, or the middle axis of the capillary or moves within a small area.

Of course, it is also conceivable to form the core 60 bent in a certain area, correspondingly following the deflections, instead of a straight core 60, shown in FIG. 6.

Since the heat transport from the outside through the capillary jacket into the liquid flowing therein is also favored by the improvement of the radial thorough mixing, the dispersion-optimized capillary in accordance with the invention can also be used as a low-dead volume solution for the temperature adaptation, for example, to adjust the temperature of the moving solvent and the sample (before entry into the separation column) to the temperature of the separation column or its contents, wherein the capillary for the temperature adaptation and the separation column are accommodated or arranged, for example, in a column thermostat, preferably, with the capillary and separation column and at least one of the two with the thermostat or capillary and separation column, separated from one another, and both thermally coupled to the thermostat.

In this way, the separation performance of the unit can be optimized by the establishment of improved thermal conditions for the separation of the sample components by the column, since a capillary in accordance with the invention requires less dead volume for the same temperature change of the mobile solvent flowing therein or the sample, compared with other designs.

Above all, the embodiment with periodically elliptical cross sectional modifications offers the particular advantage that due to the course of the capillary by the contained liquid, which is a straight line, for the most part no appreciable detours must be used for a throughflow, and thus a delay of the chromatographic analysis, in favor of a better tempering, can be avoided. If one couples the embodiment of a capillary with periodically elliptical cross sectional modifications, perhaps with a core, thermally with a thermostat, one obtains an arrangement with which one can connect the components of a chromatographic unit in a low-volume manner, and perhaps can carry out a tempering of the therein flowing medium so that it is optimized, and compared with connections made with a cylindrical or regular cross section, less longitudinal thorough mixing of successive flowing liquids is caused, which, in turn, improves the separation performance of an HPLC unit.

1. Capillary-like connector to conduct liquids, in particular, for liquid chromatography,
characterized in that
the connection (50, 55) in the direction of a main flow direction has alternating inside cross sections in a form and/or position so that alternating radial flow components are forced and thus the radial thorough mixing of the flowing liquids in the connection is reinforced and in this way, the formation of the parabolic flow profile, as known from a strictly circular cross section, is disturbed and prevented.

2. Connector according to claim 1, characterized in that the connector (50) is designed in an essentially tubular form and the center points of the alternating inside cross sections lie on an axis and the inside cross sections change in their form.

3. Connector according to claim 1, characterized in that the cross sectional areas are constant in the main flow direction of the connection and the inside cross sections change in their position.

4. Connector according to one of the preceding claims, characterized in that the inside cross sections change their position and/or form periodically in the main flow direction.

5. Connector according to one of the preceding claims, characterized in that a longish core (60) is introduced in the connector, whose outside diameter is smaller than the inside diameter of the connector (50, 55).

6. Connector claim 5, characterized in that the core (60) is located concentric to the center point curve of the connector (50, 55).

7. Connector according to claims 1 or 2, characterized in that the core (60) has a constant outside circumference.

8. Connector according to one of the preceding claims, characterized in that changes of the form and/or position of the connection cross section are not designed rotationally symmetric to the axis of the main flow direction.

9. Arrangement for liquid chromatography with at least one capillary-like connector (50, 55) according to one of the preceding claims.
